(19) United States
(12) Patent Application Publication
(10) Pub. No.: US 2014/0261032 A1
(43) Pub. Date: Sep. 18, 2014

(54) Coating Head for Printers and Coaters

(71) Applicant: P. Kenneth Deneka, Allentown, NJ (US)

(72) Inventor: P. Kenneth Deneka, Allentown, NJ (US)

(21) Appl. No.: 13/832,410

(22) Filed: Mar. 15, 2013

(51) Int. Cl. B41F 23/08

(52) U.S. Cl. CPC B41F 23/08
USPC 101/216; 118/262

(57) ABSTRACT

A coating head for coating an engraved surface on a coating cylinder of a printing press is provided including a main body having a longitudinal cavity for liquid, open to the coating cylinder and having a seal to substantially seal said main body to the coating cylinder where the cavity has an injection zone providing for a liquid pressurizing zone within a portion of the cavity in the main body. The main body has an inlet to provide liquid to a supply chamber and an outlet to exhaust said liquid and air from an exhaust/return chamber. The seal includes at least a trailing doctor blade and a metering doctor blade, where the trailing doctor blade is at an angle of three to twelve degrees relative to a tangent of the coating cylinder taken at a center of the injection zone.

### BACKGROUND OF THE INVENTION

This invention pertains to the art of printing and coating for, for example, printing presses, and more particularly to an improvement in printers or coaters having a new and improved device for supplying ink or other liquid to a coating cylinder.

Food packaging, cartons, containers, periodicals, newspapers, and other like items are commonly printed by means of flexographic or gravure roll printing presses. Materials used in some of these applications are constructed of multiple layers which are laminated using adhesives and coatings applied by gravure roll application. Devices in current use to supply ink or adhesive or coating to a coating cylinder in such a press or coater/laminator, or the like, typically have a metal body to which clamps are used to hold in place flexible thin blades which contact the surface of the coating cylinder over its entire length. With the length of the prior coating head oriented along the long center line axis of the coating cylinder, the flexible blades form a liquid seal in the axial direction. At the ends of the device are seals cut to an appropriate shape and clamped at the end to form a liquid seal at each end of the device. The device is then pressed to the radial surface of the coating cylinder and a liquid seal is achieved. These prior devices have what are known generically in the art as a dual enclosed doctor blade system. A dual enclosed doctor blade system typically has two or more flexible blades, end seals and use a pump to circulate liquid through the device.

Improvements to these printing heads were disclosed in U.S. Pat. No. 5,826,509 (Deneka) and U.S. Pat. No. 5,988,064 (Deneka). These patents are directed to a coating head device for coating an engraved surface on a coating cylinder of a printing press. The coating head device has a main body with a longitudinal cavity for liquid, open to the coating cylinder and substantially sealable to the coating cylinder. The cavity has an injection zone providing for a zone pressurizing the liquid within a portion of the cavity in the main body to compel liquid into cells in the engraved surface of the coating cylinder. The main body has an inlet to provide liquid to a supply chamber and a return to exhaust liquid from an outlet section. The coating head device has a pair of doctor blades and end seals disposed on the main body to seal the coating head against the coating cylinder. The doctor blades here are at an angle of approximately 18 degrees relative to a tangent of the coating cylinder taken at a center of the injection zone, here, parallel to the vertical back surface of the coating head device. See angle Y of FIG. 2B.

The chamber design as shown in U.S. Pat. No. 5,826,509 (Deneka) and U.S. Pat. No. 5,988,064 (Deneka) has been successful in delivering high quality print for extended run periods while at the same time reducing leaking to a very low acceptable level. However, this is true only up to run speeds of about 1000-1200 feet per minute. At higher speeds, persistent leakage starts to occur at the point where the blade sealing the supply cavity meets the surface of the engraved roll. The rate of leakage increases sharply as the run speed increases and becomes commercially unacceptable due to the cost of ink lost and resultant maintenance problems incurred as ink spreads into press components. These problems are inert to modifications in adjustments or support systems. While ink leaking out of the chamber is the biggest problem, there are other problems as well: increased foaming of water base ink, pulsing of the chamber body itself causing horizontal striations in the print, accelerated rate of wear of the blades causing more press downtime to change, shifting printed color densities, and voids (starvation) in the print images. As a result, the current chamber is not useful at higher speeds.

During approximately the past five years, flexographic press manufacturers have been promoting and producing flexographic printing presses with increasing line speeds. These improved presses advertise speeds of up to 2800 feet per minute. While these presses can transport a substrate at these speeds, they have great difficulty in providing for successful sustained printing at these speeds. To be considered successful, a press must be able to print images of consistent quality and be able to contain the ink such that leaking is not a material issue, and the press must be able to properly meter the surface of the engraved roll so as to allow for clean printing without the need to wash the printing plates. The press must accomplish these tasks for a sustained period of time. Prior to the present invention, it is believed that no coating head met this criteria.

All references cited herein are incorporated herein by reference in their entireties.

### BRIEF SUMMARY OF THE INVENTION

This invention relates to a printing or coating press and coating head such that ink or other liquid can be supplied to a coating cylinder in a superior manner to those in use prior to the present invention. More particularly, the invention is concerned with a press utilizing a coating head having dual enclosed doctor blades and, preferably, an internal ink cavity divided into three distinct zones rather than a single internal cavity.

The coating head for coating an engraved surface on a coating cylinder of a press includes a main body having a longitudinal cavity having three sections: a supply chamber, an injection zone and an exhaust/return chamber. The cavity is open to the coating cylinder and has a seal to substantially seal the main body to the coating cylinder. The injection zone provides for a liquid pressurizing zone within a portion of the cavity in the main body. The exhaust/return chamber is above the injection zone and is open to the coating cylinder. This cavity serves as an exhaust for excess ink. The main body has an inlet to provide liquid to the supply chamber, and an outlet to exhaust the liquid and air from the exhaust/return chamber. The seal includes at least a trailing doctor blade and a metering doctor blade, where the trailing doctor blade is at an angle of three to twelve degrees (and preferably approximately seven degrees) relative to a tangent of the coating cylinder taken at a center of the injection zone. As shown in the figures, the back surface of the coating head is parallel to a tangent of the coating cylinder taken at the center of the injection zone. Liquid supplied through the inlet may be substantially kept from leaking from an interface created by the coating head and the coating cylinder.

A printing press apparatus is also provided which includes a rotatable coating cylinder having an engraved surface, the engraved surface having a plurality of cells, a rotatable printing cylinder in rolling contact with the coating cylinder and having a printing plate mounted thereon, and a rotatable backing cylinder disposed adjacent to the printing cylinder such that printing material may be fed through a slot created between the printing cylinder and the backing cylinder. A supply pump is provided for supplying liquid to a coating head. The coating head is as described above.

Objects and advantages of the present invention will become apparent from the following description taken in conjunction with the accompanying drawings.

### BRIEF DESCRIPTION OF SEVERAL VIEWS OF THE DRAWINGS

The invention will be described in conjunction with the following drawings in which like reference numerals designate like elements and wherein:

FIG. 1 is a simplified side elevational view of a press in accordance with one preferred embodiment of the present invention;

FIG. 2A is a side elevational view, partially cutaway of the press of FIG. 1 with a seal plate removed;

FIG. 2B is a side elevational view, partially cutaway of a prior art press with a seal plate removed;

FIG. 3 is a partial, magnified view of the engraved surface of a coating cylinder as used in the press of FIG. 1;

FIG. 4 is a simplified perspective view of a coating head device as used in the printing press of FIG. 1, depicted in partially exploded form; and

FIG. 5 is a schematic of the action of the coating head as used on the printing press of FIG. 1.

### DETAILED DESCRIPTION OF THE INVENTION

The invention will be illustrated in more detail with reference to the following embodiments, but it should be understood that the present invention is not deemed to be limited thereto.

Referring now in detail to the drawings, wherein like reference numerals indicate like elements throughout the several views, there is shown in FIG. 1, a printing or coating station 10 in accordance with an exemplary embodiment of the present invention, in simplified form. The printing or coating station 10 of the present invention may be a conventional flexographic printing station, or any other printing or coating station wherein a coating head 12 is used in conjunction with an anilox roll, gravure cylinder, or other ink or liquid applicator roll, hereinafter referred to as coating cylinder 14. As seen in FIG. 1, a conventional flexographic station 10 has a printing cylinder 16 (or plate cylinder) and a backing cylinder 18 between which sheets of, or continuous roll fed substrate, for example, paper 20, are sequentially advanced. A printing plate 22 is mounted on the printing cylinder 16, for example, by vacuum adhesive. As coating cylinder 14 rotates in direction A, the coating head 12 applies a liquid such as ink to the coating cylinder 14 which has an engraved surface 24 (see FIG. 3). Preferably, the coating head 12 is installed on the printing or coating station 10 at either the 3:00 (shown) or 9:00 positions. The ink or other liquid is provided to cells 26 in the engraved surface 24 of the coating cylinder 14 for holding liquid to be transferred to the printing plate 22 (see FIG. 3). The ink is supplied to the coating cylinder 14 by the coating head 12 of the current invention. The ink or other liquid is supplied to the coating head 12 from ink drum 28 through liquid supply pipe 30 to inlet orifice 32 of the coating head 12. Although this description generally refers to the liquid utilized as being ink, any liquid having generally Newtonian properties may be used.

Coating cylinders 14 with different engraved surfaces 24 (also called surface screens) are available, e.g., surfaces formed with small pyramids, or quadrangles, or hexagonal shapes, or having channels therein, etc. The present invention will operate under a wide variety of these surfaces. These different engraved coating cylinders may provide different printing qualities. In the exemplary embodiment, as seen in FIG. 3, the engraved surface 24 is of a hexagonal configuration. These engraved surfaces may be, for example, laser engraved at, for example 700 lines per lineal inch. The surface may also be chrome plated to provide for corrosion resistance.

FIG. 1 depicts a vertical section through the printing or coating station 10 and shows a preferred arrangement of the main relevant operating elements required for the present invention.

At the top is a backing cylinder 18 which cooperates with a printing cylinder 16 having mounted thereon printing plate 22. The cylinders 14 and 16 rotate respectively in the direction of arrows A and B to feed the sheet 20 therebetween in the direction of the arrow D with the sheet 20 being printed on the underside thereof. The coating cylinder 14 is rotated counterclockwise in the direction of the arrow A and inks or coats the printing plate 22. Ink is supplied to the surface of the coating cylinder 14 via the coating head 12 of the current invention.

The coating head 12 employs a twin-chamber, three zone configuration that flushes air from the coating cylinder cells 26 and fully charges each cell 26 with ink or other liquid, yielding a metered, precise coating weight of ink transfer on every rotation. As can be seen in FIGS. 1 and 2A, a trailing doctor blade 34 clears the coating cylinder engraved surface 24 and breaks the boundary layer of air that impedes cell-filling in prior coating pan systems. Liquid is substantially contained within the coating head 12 and associated tubing (inlet 36, outlet 38; see FIG. 1), pumps 40, 42 (partially shown in FIG. 1), and recirculation container.

The coating head 12 has a main body 44 of, for example, aluminum, to which are bolted two clamps 46, 48. The clamps 46, 48 each hold in place flexible thin doctor blades 34, 50 which, when properly positioned, contact the engraved surface 24 of the coating cylinder 14 over substantially its entire length. O-ring seals may be used to further seal the doctor blades 34, 50 to the body 44 of the coating head 12. The length of the coating head 12 is oriented along the axial center axis X (see FIG. 1) of the coating cylinder 14 thus the flexible blades 34, 50 form a liquid seal. Other materials can be used for the main body of the coating head 12 such as stainless steel, and, additionally, the material can be plated or anodized to reduce corrosion.

As can be seen in FIG. 4, at each end 52, 54 of the coating head 12 is a seal 56 made of plastic or rubber foam or felt fabric cut to appropriate shape and clamped at the end with seal plate 58, with, for example, screws 60 into threaded holes 62 to form a liquid seal at each end of the coating head 12. Preferably, 100% natural wool seals are used, saturated in petroleum jelly due to the enhanced abrasion characteristics of the wool, and the fact that the petroleum jelly is generally not soluble using any routine liquid used in the printing industry.

As can be seen in FIGS. 1 and 2A, in operation, the coating head 12 is pressed to the engraved surface 24 of the coating cylinder 14 and a substantially full liquid seal is achieved. Thus, the coating head 12 can be brought into alignment with the coating cylinder 14 under a minimum amount of pressure, whereby doctor blades 34, 50 require replacement on a significantly reduced basis. Prior users often used polyester felt in combination with fifty weight gear oil, with the associated problems of fibers of polyester tracking through print and dissolving of the gear oil by solvent-based inks and coating solutions and by many solutions for cleaning used, thereby contaminating the inks or solutions.

As can be seen in FIG. 2A and in schematic in FIG. 5, in operation of a printing press 10 utilizing the elements of the present invention, ink or other liquid is fed in under constant pressure by supply pump 42 through supply tubing 30 through inlet orifice 32 of coating head 12 into the supply chamber 64, i.e. the lower chamber, in the coating head 12, and floods the engraved surface 24 of cells 26 of the coating cylinder 14 where the coating head 12 makes contact with the coating cylinder 14. The formation of bubbles or foam within the supply chamber 64 is inhibited due to the fragility of the bubble walls when placed under the pressure of the ink or other liquid pumped in. Here, the entire supply chamber 64 is filled with liquid, as can be seen in FIG. 2.

Pressurized ink is then forced into the injection zone 66, a narrow passageway between the supply chamber 64 and the exhaust/return chamber 68 (to be described in detail below). The ink is forced by pressure of the supply pump 42 to induce flow. Pressure of liquid passing through the injection zone 66, in the center 70 of the injection zone 66, spikes upward due the slight narrowing of the gap 72 due to the flat section of the injection zone 66 located on the coating head 12 in relation to the radius of the coating cylinder 14. That is, the cross-sectional area of the injection zone 66 is least at the center point 70 of the injection zone 66. For ink, this gap 72 is preferably approximately 0.140 to 0.200 inches at its narrowest point, depending on the diameter of the coating cylinder 14. Since the pressure in injection zone 66 spikes upward, ink is forced into the deepest recesses of every cell 26 in the coating cylinder 14. Moreover, trapped air is forced out of the liquid and into the exhaust/return chamber 68. Exhaust/return chamber 68 is partially filled with liquid and partially filled with air, as can also be seen in FIG. 2A. Thus, substantially no air is left in the bottom of the cells 26, allowing for full-cell charging. Coating weights are therefore precisely metered, advantageously providing for more uniform color and crisper and cleaner print definition throughout a print run.

The metering doctor blade 50 knifes away residual ink or coating as the coating cylinder 14 rotates. Excess ink or other liquid is captured in the exhaust/return chamber 68, along with the exhaust air flushed from the cylinder cells. Substantially only the ink or coating in each fully charged cell remains.

Supply chamber 64 and exhaust chamber 68 are preferably half-circular in cross section as can be seen in FIGS. 1 and 2, however, many cross-sectional shapes will operate properly.

Foaming, frothing, or bubbling of the liquid is undesirable in that it can cause washed-out colors or inconsistent coating weight, particularly in water-based systems. The coating head 12 of the present invention uses the injection zone 66 to force ink or coating to the bottom of every cell 26 on the engraved surface 24 of the coating cylinder 14, forcing trapped air out and fully charging every cell 26. Also, by eliminating boundary air by the trailing doctor blade 34 before the portion of the engraved surface 24 of the coating cylinder 14 enters the coating head 12, the coating head 12 prevents aeration of ink or liquid and substantially reduces evaporation of water or solvents. Solids in the ink or coating remain in suspension, at the proper proportions, to provide for consistent coating weights. Color shifting is minimized because solvent or water evaporation is minimized. The need to add make-up water or solvent is therefore also minimized.

In coating and printing systems, cell “dwell time” in the coating medium is reduced as a result of increased coating cylinder 14 rotational speed. The boundary layer of air that forms around the coating cylinder 14 as it turns is particularly apparent as rotational speeds are increased. In prior art devices, this boundary layer typically compresses at the engraved surface 24 of the coating cylinder 14, hampering coating, ink or other liquid from filling cells 26. In prior single chamber systems, the boundary layer is broken by a doctor blade, but there is not sufficient pressure from the supply chamber to overcome and displace air trapped in the bottom of each cell. In the present system, pressure at the center 70 of the injection zone 66 builds with increased rotational speed, creating a stream of increasingly pressurized ink. Substantially every cell 26 is fully charged, even at high rotational speeds.

In one exemplary embodiment, the present invention is directed to a modified version of the designs previously disclosed in U.S. Pat. No. 5,826,509 (Deneka) and U.S. Pat. No. 5,988,064 (Deneka), which are fully incorporated by reference. The primary problem in this prior art exists in the supply chamber 64—that cavity into which ink is first pumped. The nature of that cavity 64 is such that the ink within will be forced to spin in a generally circular pattern that retards the ability to force it through the injection zone 66, i.e., the gap between the flat of the coating head 12 and the coating cylinder 14. Pump supply pressures must be increased to gain sufficient flow to allow for transfer of the ink through the injection zone 66 and therein allow for transfer into the individual cells 26 of the engraved surface 24. The increased pressure thereby causes ink to force through the contact point of the trailing doctor blade 34 and the engraved surface 24 of the coating cylinder 14 thereby being a source of leaking. In the present invention, as shown in FIG. 2A, the angle of the trailing doctor blade 34 is three to twelve degrees, and preferably approximately 7 degrees, relative to a tangent of the coating cylinder 14 taken at the center 70 of the injection zone 66 of the coating head 14. As shown herein, the tangent of the coating head 12 is a vertical line and is parallel to the back surface 76 of the coating head 12. Previously, the angle of this blade was 18 degrees. The result is that the supply chamber 64 is flattened relative to the prior art print heads discussed above. The largely circular pattern is substantially interrupted and shows a much greater predisposition to lateral flow. This has the benefit of reducing the ink pressure at the contact point 74 of the blade tip to the engraved surface 24 of the coating head 14. A further benefit is that ink can be distributed across the lateral face of the engraved surface 24 with less ink pressure. Yet another benefit is that the volume of ink in the supply chamber 64 is reduced, thereby lessening the dwell time of a unit of ink within the chamber 64. The reduction of dwell time within the chamber 64 has a direct beneficial effect of reducing foam generation with water based inks.

An additional benefit as a result of less ink pressure is the ability to retain good metering of the engraved surface 24 upon exiting the supply chamber 64 and sealing of the chamber 64 while using less chamber-to-engraved roll pressure. This lower pressure directly provides an improvement of blade life that can be as high as two times and improves the efficacy of cleanly knifing excess ink from the surface of the engraved roll.

Uniformity of print quality is substantially unchanged with line speed when measured from 400 feet per minute to 2200 feet per minute when using normal commercial quality ink where proper controls of the ink are maintained.

It is important that viscosity is maintained at an appropriate level as well as pH in the case of water based inks.

This new design provides important improvements, particularly in the area of leakage at speeds below 1000 feet per minute and thereby useful for older slower printing presses.

This new geometry is counter-intuitive in that shrinking the supply chamber 64 volume would appear to result in higher internal ink pressure and thereby worsen leakage problems. Further, flatter blade point contact results in much faster wear of the blade thereby requiring more press downtime for changes. In fact, the opposite is seen to occur in both areas with no detriment to other concerns. All of the benefits of the former three zone chamber are maintained in this new invention in terms of creating a pressure spike in the center 70 of the flat injection zone 70 thereby completely exchanging all air in an empty cell 26 with ink thus providing for uniform print density at run speed. Tests have been run at speeds up to 3500 feet per minute with no loss of uniformity. At speeds higher than 2200 feet per minute foaming of water base inks becomes unacceptable over sustained run times of several hours.

The present design allows for using only slight flex of the metering doctor blade 50 (i.e., the blade which doctors the engraved surface 24 upon exiting the exhaust chamber 68. A slight flex is required to prevent blade chatter and to precisely remove virtually all excess ink from the engraved surface 24 leaving only ink residing in the cells 26. Therefore, the running time of the printing station 10 between printing plate washes is greatly increased. If the metering is less precise, some ink will be left on the engraved surface 24 causing the printing plate to become “muddy” and “blurry.” This is particularly troublesome in high quality printing of half tones, vignets, and fine screens. It is not uncommon today to see high speed presses requiring plate washes every 30-45 minutes (a process that can take considerable time, e.g., 5-10 minutes per printing plate), resulting in down time and material loss. The new design can go as long as six to eight hours between washes, thereby dramatically improving productivity.

Lower blade pressures also reduce the threat of the blades 34, 50 causing unwanted score lines in fine line coating cylinders 14. Common blade to coating cylinder pressures range from 1 to 3 pounds per linear inch of blade width. The new design of the present invention allows for 0.25 to 0.6 pounds per linear inch of blade width. Blade life can be up to 24 hours for seven days, where prior systems may require daily changes.

While the invention has been described in detail and with reference to specific examples thereof, it will be apparent to one skilled in the art that various changes and modifications can be made therein without departing from the spirit and scope thereof.

What is claimed is:

1. A coating head for coating an engraved surface on a coating cylinder, comprising:
(a) a main body having a longitudinal cavity for liquid, open to said coating cylinder and having a seal to substantially seal said main body to said coating cylinder, said cavity having an injection zone providing for a liquid pressurizing zone within a portion of said cavity in said main body;
(b) said main body having an inlet to provide liquid to said supply chamber;
(c) said main body having outlet to exhaust said liquid and air from an exhaust/return chamber; and
(d) said seal including at least a trailing doctor blade and a metering doctor blade, said trailing doctor blade being at an angle of three to twelve degrees relative to a tangent of the coating cylinder taken at a center of the injection zone;
whereby liquid supplied through said inlet may be substantially kept from leaking from an interface created by said coating head and said coating cylinder.

2. The coating head of claim 1, wherein the trailing doctor blade is at an angle of approximately seven degrees relative to a tangent of the coating cylinder taken at a center of the injection zone.

3. A printing press apparatus comprising:
(a) a rotatable coating cylinder having an engraved surface, said engraved surface comprising a plurality of cells;
(b) a rotatable printing cylinder in rolling contact with said coating cylinder having a printing plate mounted thereon;
(c) a rotatable backing cylinder disposed adjacent said printing cylinder such that printing material may be fed through a slot created between said printing cylinder and said backing cylinder;
(d) a supply pump for supplying liquid to a coating head;
(e) said coating head for coating said engraved surface on said coating cylinder comprising:
(i) a main body having a longitudinal cavity for liquid, open to said coating cylinder and having a seal to substantially seal said main body to said coating cylinder, said cavity having an injection zone providing for a liquid pressurizing zone within a portion of said cavity in said main body;
(ii) said main body having an inlet to provide liquid to said supply chamber;
(iii) said main body having outlet to exhaust said liquid and air from an exhaust/return chamber; and
(iv) said seal including at least a trailing doctor blade and a metering doctor blade, said trailing doctor blade being at an angle of three to twelve degrees relative to a tangent of the coating cylinder taken at a center of the injection zone.

4. The printing press of claim 3, wherein the trailing doctor blade is at an angle of approximately seven degrees relative to a tangent of the coating cylinder taken at a center of the injection zone.
